(19) United States
(12) Patent Application Publication
(10) Pub. No.: US 2008/0222649 A1
(43) Pub. Date: Sep. 11, 2008

(54) Method and computer program for managing man hours of multiple individuals working one or more tasks

(75) Inventors: Todd Williamson, Monroe, LA (US); Tim Norman, Monroe, LA (US); Chris Turner, Monroe, LA (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: Williamson Industries, Inc., Monroe, LA (US)

(21) Appl. No.: 11/714,612

(22) Filed: Mar. 6, 2007

(51) Int. Cl. G06F 9/46

(52) U.S. Cl. 718/107

(57) ABSTRACT

A method and computer program are provided for managing man hours of multiple individuals working one or more tasks during a predefined time period that include selectively opening a plurality of tasks of differing task characteristic and task type, selectively associating one or more individuals to one of the open plurality of tasks, selectively unassociating at least one of the associated one or more individuals, maintaining at least one timer for each of the open plurality of tasks, selectively closing one or more of the open plurality of tasks, and selectively outputting an invoice for the closed plurality of tasks based on the bid price of each of the open plurality of tasks. One or more of the individuals are associated and unassociated prior to completion of the open one or more tasks. The at least one timer maintains a total time for all of the associated one or more individuals for each of the open plurality of tasks.

### BACKGROUND OF THE INVENTION

1. Field of the Invention

The present invention relates to the managing man hours of individuals and, more particularly, to a method and computer program for managing man hours of multiple individuals working one or more tasks.

2. Discussion of the Background

Companies often have a need to manage and/or calculate the number of man hours that their employees and/or contractors dedicate to a task, such as a job, an assignment, a project, an activity, or the like. Companies commonly use punch cards, time clocks, or ledger entries to record the number of man hours dedicated to a task for each employee. Unfortunately, such methods are not efficient where the number of workers assigned to a task varies during the day or the workers are frequently reassigned from one task to another task. Because of this, companies often resort to crude estimations of the total number of man hours. Further complicating such determinations are situations in which many tasks are being simultaneously managed. This is especially problematic in situations where the tasks being managed have different levels of complexity, different characteristics, or varying durations and/or time constraints. Other factors effecting the number of man hours actually worked for a particular task include the availability of workers and equipment at different time periods which are not often tracked.

Thus, as noted above, there currently exists deficiencies in managing man hours of individuals assigned to a task that are known in the prior art.

### SUMMARY OF THE INVENTION

Accordingly, one aspect of the present invention is to provide a computer program embodied on a computer readable medium for managing man hours of multiple individuals working one or more tasks during a predefined time period. The computer program includes a first computer code for selectively opening a plurality of tasks of differing task characteristic and task type, a second computer code for selectively associating one or more individuals to one of the open plurality of tasks, a third computer code for selectively unassociating at least one of the associated one or more individuals, a fourth computer code for maintaining at least one timer for each of the open plurality of tasks, a fifth computer code for selectively closing one or more of the open plurality of tasks, and a sixth computer code for selectively outputting an invoice for the closed plurality of tasks based on a bid price for each of the tasks. One or more of the individuals are associated and unassociated prior to completion of the open one or more tasks. The at least one timer maintains a total time for all of the associated one or more individuals for each of the open plurality of tasks.

Another aspect of the present invention is to provide a method for managing man hours of multiple individuals working one or more tasks during a predefined time period. The method includes selectively opening a plurality of tasks of differing task characteristic and task type, selectively associating one or more individuals to one of the open plurality of tasks, selectively unassociating at least one of the associated one or more individuals, maintaining at least one timer for each of the open plurality of tasks, selectively closing one or more of the open plurality of tasks, and outputting an invoice for the closed plurality of tasks based on a bid price for each of the tasks. One or more of the individuals are periodically associated and unassociated prior to completion of the open one or more tasks. The at least one timer maintains a total time for all of the associated one or more individuals for each of the open plurality of tasks.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIG. 1 is a block diagram illustrating the overall system according to an embodiment of the present invention;

FIGS. 2-6 are flow charts illustrating the overall system functionality according to an embodiment of the present invention; and

FIGS. 7-29 illustrate an exemplary computer program for managing man hours of multiple individuals working on one or more tasks according to an embodiment of the present invention.

### DETAILED DESCRIPTION OF THE PREFERRED EMBODIMENTS

Referring now to the drawings, wherein like reference numerals designate identical or corresponding parts throughout the several views, preferred embodiments of the present invention are described.

The present invention relates to a method and computer program for managing the man hours of individuals working on one or more tasks. According to the present invention, a user may control in real time the number of individuals working on each task and the billing associated therewith. Specifically, any number of tasks may be managed, any number of workers may be reassigned from one task to another task, and the number of workers at any given time period may be increased or decreased, in real time for each task. This is particularly useful in situations in which the number of individuals assigned to a particular task tends to fluctuate during a given work period. The present invention calculates the total man hours required to perform a given task based on the accumulated time of all workers for that task.

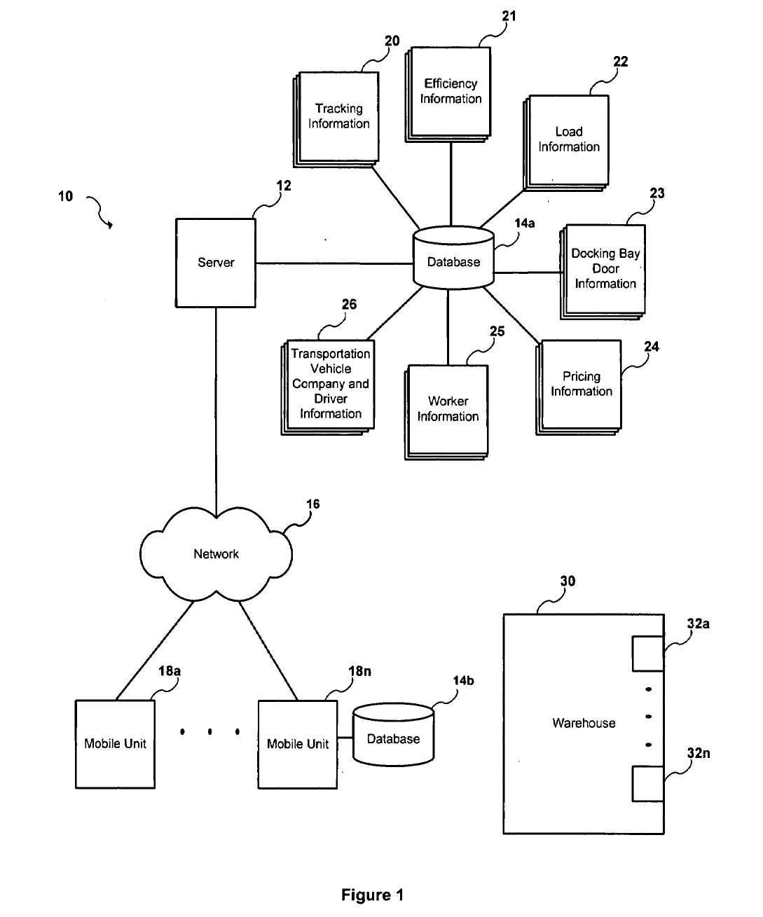

Referring to FIG. 1, a block diagram illustrating the overall system 10 according to an embodiment of the present invention are shown. The present invention relates to a method and computer program for managing man hours of multiple individuals working on one or more tasks. The system 10 includes a computer or server 12. The server 12 is in communication with one or more databases 14a. The one or more databases 14a may contain, without limitation, tracking information 20, efficiency information 21, load information 22, docking bay door information 23, pricing information 24, worker information 25, and transportation vehicle company and driver information 26. One or more mobile units (18a-18n) are in communication with the server 12 over a wireless network 16. The mobile units (18a-18n) include, without limitation, PDAs, laptop computers, electronic tablets or the like. A computer program is executed on the one or more mobile units (18a-18n). The computer program may be configured to be in direct or indirect communication with one or more databases 14a and/or one or more databases 14b. Other configurations are obviously possible within the scope of the present invention. For instance, in one embodiment, the system 10 may utilize conventional non-wireless computers, rather than mobile units (18a-18n), in communication using a non-wireless network. In another embodiment, a stand-alone computer replaces the server 12 and the mobile units (18a-18n). In this embodiment, the computer program is executed on the stand-alone computer and a network is optional.

In one embodiment, tracking information 20 relating to the task, including, without limitation, the number of man hours, the number of workers at any given time, the peak number of workers, the characteristic of the task, and the complexity of the task, is periodically stored to one or more databases 14a. Optionally, efficiency information 21, including, without limitation, the amount of time required for workers to begin working on the task and complete the task is also stored to one or more databases 14a. The tracking information 20 is used to calculate the optimal man hours and the optimal number of workers for a task having similar characteristics and/or complexity. For instance, the optimum number of workers that should be assigned to a given task and the optimum number of man hours for the task are calculated by comparing the characteristic and complexity against the tracking information of prior tasks. The optimum number of workers for different phases of the task may also be calculated. Said another way, precisely when during a task workers should be increased or decreased may be calculated in advance such that the utilization of the workers may be optimized.

Additionally, a traditional time-clock may be maintained for each worker. In one embodiment, a bonus check is split among some or all of the workers for any given day. The bonus check is based on the combined efficiency of completing the task. Such efficiency may be calculated based on differences between the total man hours required to complete a task as compared with tracking information 20 of tasks having similar characteristics. Thereby, the workers are motivated to increase their bonus check by increasing their efficiency to complete a given task.

Possible implementations of the present invention may vary. For instance, according to one possible implementation, a computer program is used to manage the man hours of workers unloading and loading transportation vehicles at one or more docking bay doors (32a-32n) in a warehouse or distribution center 30. Other possible implementations of the present invention, without limitation, include managing the man hours of workers unloading and/or loading articles from one or more transportation vehicles as discussed below. Transportation vehicles as used herein include, without limitation, trucks, automobiles, trains, light-rail, boats, seaplanes, airships, airplanes, or the like. Articles as used herein include, without limitation, containers, pallets, crates, boxes, or the like.

Loading and/or Unloading Transportation Vehicles Example

For purposes of illustration, an exemplary computer program for unloading and loading transportation vehicles at one or more docking bay doors (32a-32n) utilizing the present invention is now described. It is to be understood, however, that other implementations are possible within the scope of the present invention.

The number of individuals needed to optimally load and/or unload articles of a transportation vehicle at a docking bay door (32a-32n) tends to fluctuate over time. Such fluctuation may be due to several factors, including, without limitation, worker availability, and the number of workers preferred at different phases of the loading and/or unloading process. For example, a smaller number of workers may be preferred to work within the limited confines of a transportation vehicle to reduce the number of times the workers obstruct one another due to the confined area, whereas, a larger number of workers may be preferred to work in non-confined areas, such as moving articles within a warehouse and/or loading area. Other factors may also effect the preferred number of workers, such as the availability of loading and/or unloading equipment. Based on these factors, the number of workers assigned to load and/or unload articles may vary at different phases of the process. Using a computer program, the total number of man hours required to load and/or unload articles of a transportation vehicle is calculated based on the accumulated time of all workers assigned to load and/or unload a transportation vehicle at a given docking bay door (32a-32n). Load information 22 including, without limitation, the number of workers assigned to load and/or unload articles at any given time, the total man hours, the time period having the highest number of workers, and the time period having the fewest number of workers and the required equipment, may be stored in one or more databases 14a. Such information may also be separated into tracking information 20, efficiency information 21, load information 20 and/or docking bay door information 23. Other information may also be stored in one or more databases 14a, such as pricing information 24, worker information 25, and transportation vehicle company and driver information 26.

The computer program allows a user to manage any number of docking bay doors (32a-32n) and to reassign a worker from one docking bay door (32a-32n) to another docking bay door (32a-32n) in real time. The computer program also maintains efficiency information 21 relating to the loading and/or unloading process, including, without limitation, the time required after the transportation vehicle arrives until workers begin loading and/or unloading the transportation vehicle.

According to one embodiment, the computer program allows the efficiency of the workers to be improved. Tracking information 20 relating to loading and/or unloading the transportation vehicle, including, without limitation, the number of man hours, the number of workers at any given time, the peak number of workers, the characteristic of the load, and the complexity of the load, is periodically stored in one or more databases 14a. The tracking information 20 is used to make certain efficiency calculations, such as the optimal man hours and/or the optimal number of workers to load and/or unload a transportation vehicle having similar characteristics and/or complexity. The optimal number of workers that should be assigned at any given stage of a loading and/or unloading process and the optimal number of man hours for the assignment may be calculated by comparing the characteristic and complexity of the current load against tracking information 20 of prior loads. The optimal number of workers that should be assigned during different phases of the loading and/or unloading process may also be determined in advance. This determination may be based on a user specified duration in which the workers are given to complete the task.

Optional efficiency information 21, including, without limitation, the amount of time required for workers to begin working on the task and complete the task may also be stored in one or more databases 14a. Additionally, a traditional time-clock for each worker may be maintained by the computer program. The traditional time-clock may be used for traditional payroll management purposes.

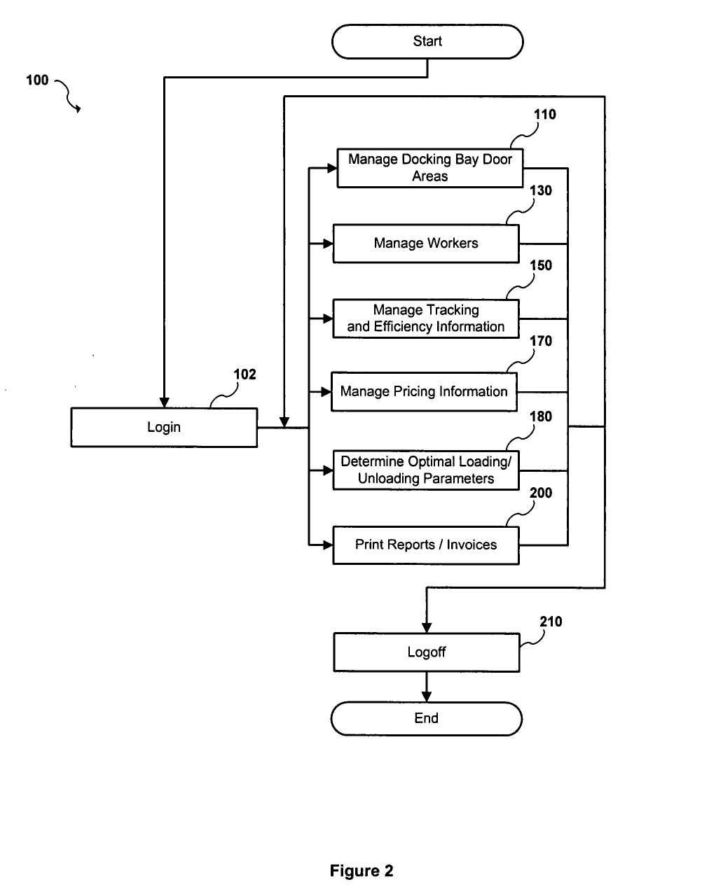

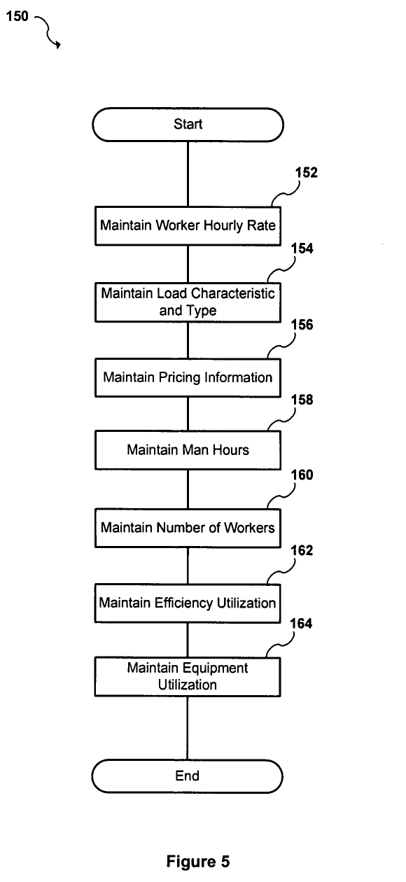

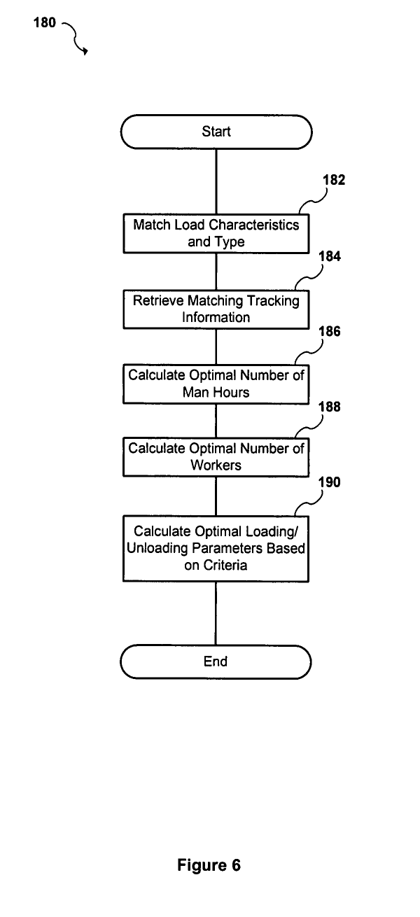

Referring to FIGS. 2-6, flow charts illustrating the overall system functionality according to an embodiment of the present invention are shown.

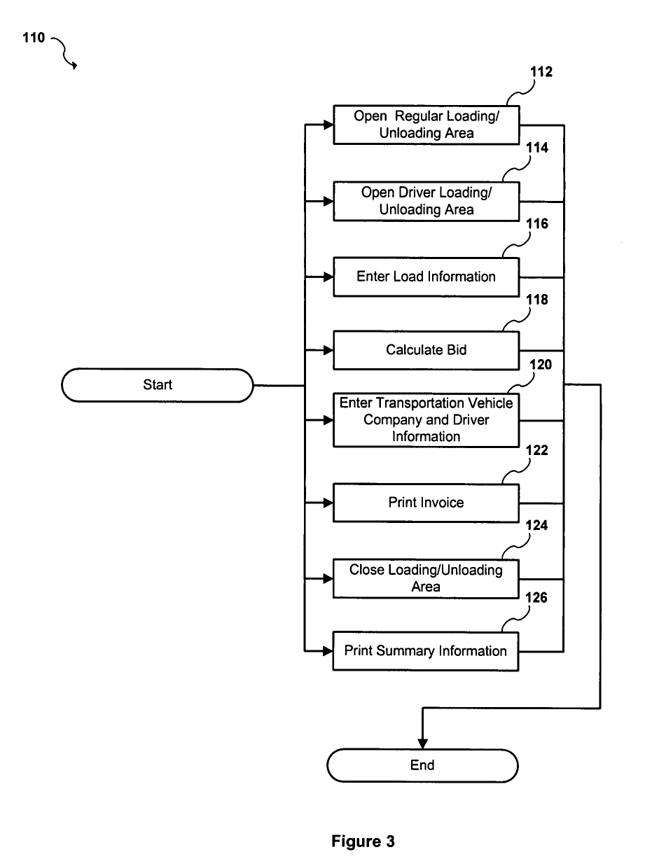

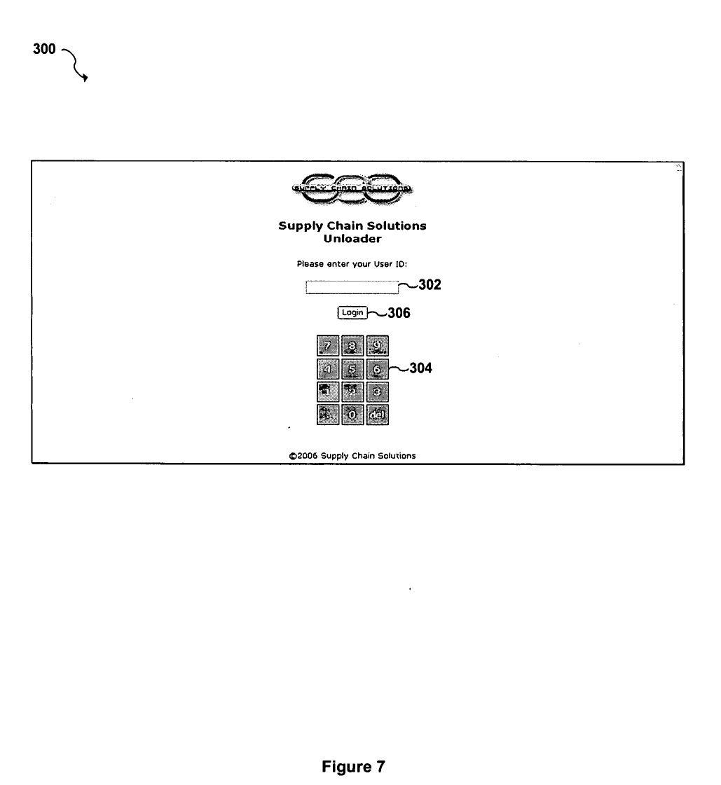

As shown at block 102 of FIG. 3, a user initially logs in to the system. This step may include presenting the user with a form that includes a username and password, and then authenticating the entered information. This step may also include presenting the user with a user interface that includes other identifying information, such as a user number. A user may login at a computer or mobile unit (18a-18n) at any time, including, without limitation, at the beginning of a work period or shift. In one implementation, the user may be presented with user interface 300, as shown in FIG. 7. User interface 300 includes a user identification text field 302, a keypad 304 and a login button 306.

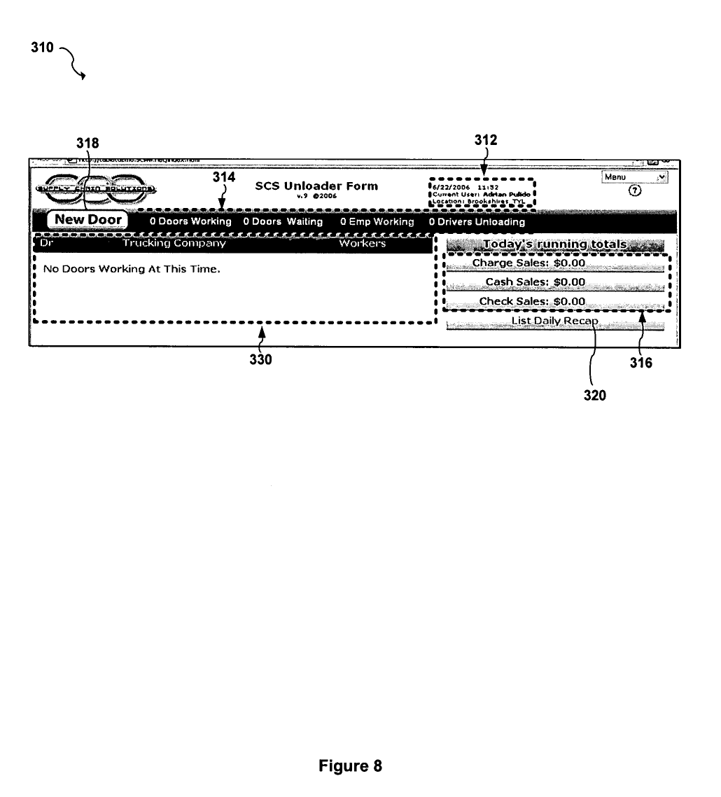

After logging in to the system, the user is presented with a user interface configured to manage the man hours of multiple workers assigned to load and/or unload one or more transportation vehicles at one or more docking bay doors (32a-32n). The user may choose to manage one or more docking bay door areas 110, manage one or more workers 130, manage tracking and efficiency information 150, manage pricing information 170, determine optimal loading and/or unloading parameters 180, or print reports and/or invoices 200. In one implementation, the user is initially presented with user interface 310, shown in FIG. 8. User interface 310 includes a user information area 312, a load status area 314, a load management area 330, a payment information area 316, an open docking bay door button 318 and a daily recap button 320.

The load status area 314 provides general information regarding the current status of the docking bay doors (32a-32n) and the number of workers currently assigned to load and/or unload transportation vehicles. In particular, the load status area 314 visually represents (i) the number of open docking bay doors (32a-32n) that have a transportation vehicle currently being loaded and/or unloaded, (ii) the number of open docking bay doors (32a-32n) that are waiting to have workers assigned to load and/or unload a transportation vehicle, (iii) the total number of workers currently assigned to load and/or unload transportation vehicles, and (iv) the total number of drivers currently loading and/or unloading their own transportation vehicle.

The payment information area 316 provides running payment totals associated with workers loading and/or unloading transportation vehicles. The payment information area 316 is separated into cash, check, and charge payments. However, other arrangements and categories are possible within the scope of the present invention.

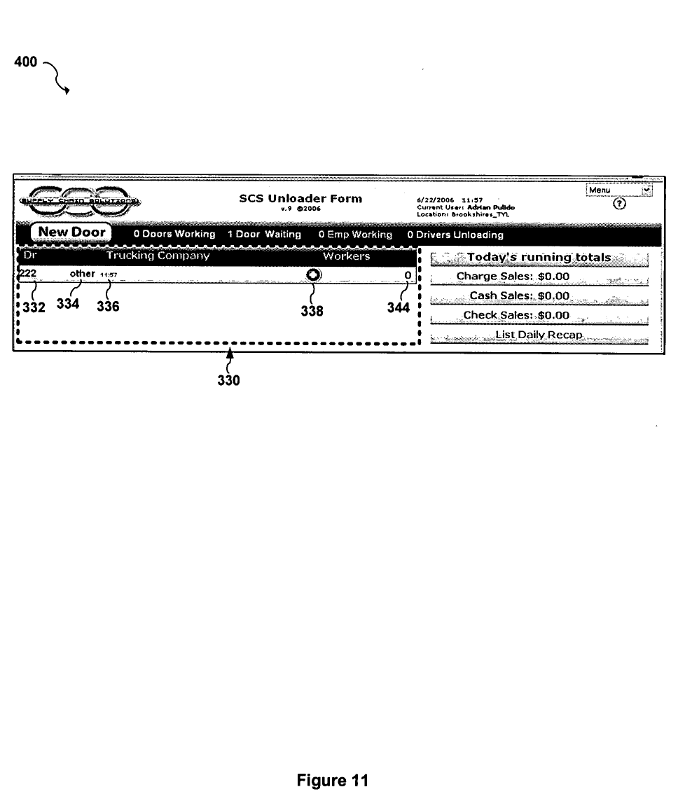

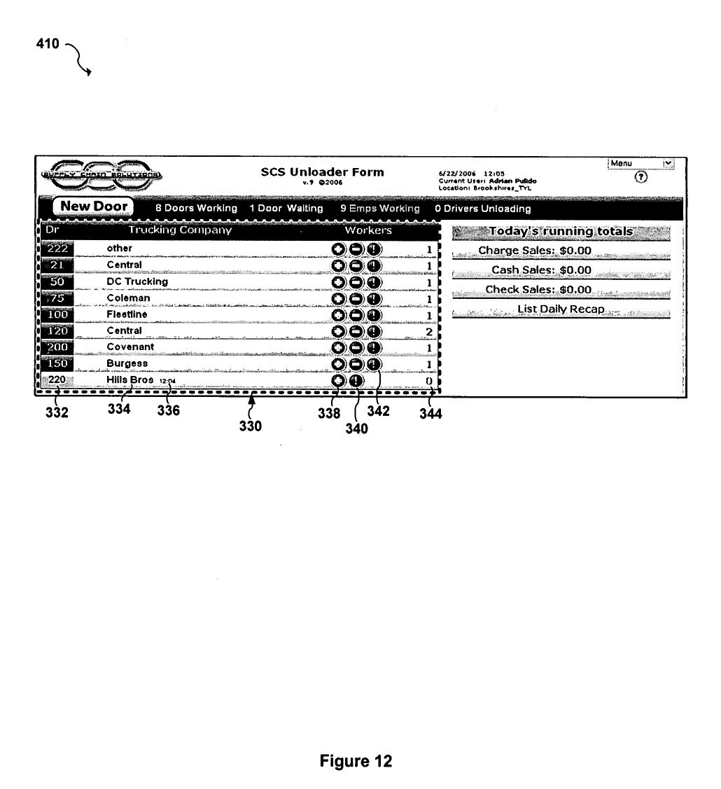

The load management area 330 displays information regarding to the open docking bay doors (32a-32n) and the workers assigned to load and/or unload transportation vehicles at those docking bay doors (32a-32n). The load management area 330 is shown in a table format. Each row of the table represents an open docking bay door (32a-32n). The columns of the table provide detail information and controls for each of the open docking bay doors (32a-32n) represented in the table. As shown in FIG. 12, the load management area 330 displays, without limitation, the dock bay door number 332, the transportation vehicle company name 334, and the number of workers 344, in column format. The number of workers 344 represents the total number of workers that are currently assigned to load and/or unload a particular transportation vehicle. The controls include, without limitation, an add worker button 338 (the “+” button), a decrease worker button 340 (the “−” button) and a worker break button 342 (the “!” button). As shown in FIGS. 11 and 12, the decrease worker button 340 (the “−” button) and the worker break button 342 (the “!” button) are not displayed if workers are not currently assigned to load and/or unload the transportation vehicle. Selection of the add worker button 338 results in the decrease worker button 340 (the “−” button) and the worker break button 342 (the “!” button) being displayed, if no workers were previously assigned to the open docking bay door (32a-32n).

### A. Managing Docking Bay Door Areas

As shown at block 110 of FIG. 3, the user may choose to manage one or more docking bay door areas. Managing one or more docking bay door areas includes, without limitation, opening and closing docking bay doors (32a-32n), entering load information 22, entering transportation vehicle company and driver information 26, entering pricing information 24, calculating bids, and printing invoice and summary information, as described below.

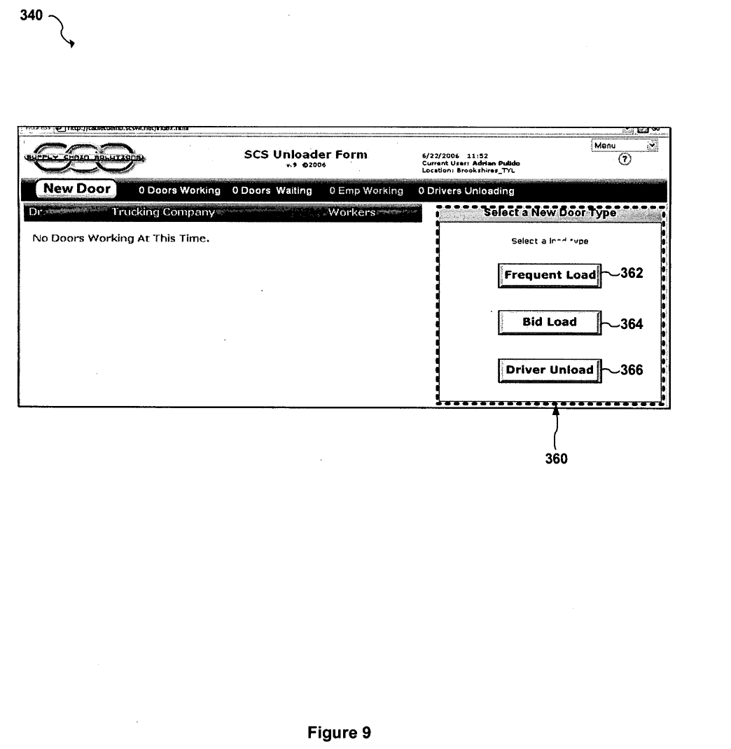

As shown at block 112 of FIG. 3, the user may choose to open one or more regular docking bay doors (32a-32n). Each docking bay door (32a-32n) is associated with a transportation vehicle to be loaded and/or unloaded. A load as used herein includes, without limitation, a regular load and a driver load. A regular load has one or more workers assigned to load and/or unload the load, whereas a driver load is a loaded and/or unloaded by the driver. Adding a docking bay door (32a-32n) may be initiated by selecting the open docking bay door button 318. In one implementation, upon selection of the open docking bay door button 318, the user is presented with user interface 340, shown in FIG. 9. User interface 340 includes an open regular load button 362, a bid load button 364, and a driver load button 366.

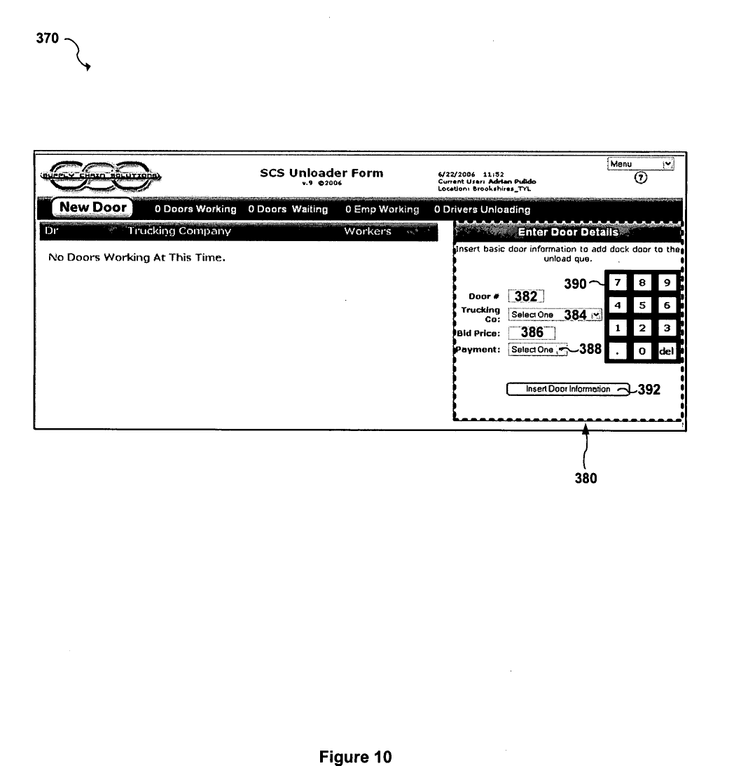

In situations where the amount to be charged is already known, the frequent load button 362 may be selected to enter load information 22 for a regular load. In one implementation, upon selection of the frequent load button 362, the user is presented with user interface 320, shown in FIG. 10. User interface 320 includes an enter door details area 380.

Using the enter door details area 380, the user may enter a docking bay door number 382, the name of the transportation vehicle company 384, a bid price 386 and a type of payment 388. The type of payment may include, without limitation, payments of cash, check, debit or charge. The bid price 386 is generally the price quoted to the driver, but may also be calculated based on previous bids. The user interface 380 may optionally include a numeric keypad 390 which may be used to enter numbers. After completing the fields in the enter door details area 380, the user selects the insert door information button 392. In one implementation, upon selection of the insert door information button 392, the user is presented with user interface 410 as shown in FIG. 12. At least some of the information entered in the enter door details area 380 is represented as a row of the load management area 330. As shown in FIG. 12, the docking bay door number 332 and the transportation vehicle 334 are represented in the load management area 330. The loading status of the docking bay door (32a-32n) may also be reflected in the load management area 330. The loading status of the docking bay door (32a-32n) includes, without limitation, a waiting state and a working state. A waiting state indicates that no workers are assigned to load and/or unload the transportation vehicle, whereas a working state indicates that one or more workers are assigned to load and/or unload the transportation vehicle. In one implementation, the loading status of the docking bay door (32a-32n) is visually in the load management area 330 using different colors. A waiting state is reflected as yellow and a working state is reflected as green. Obviously, other visual representations are possible.

Initially, when no workers are assigned to load and/or unload a transportation vehicle that is represented in the load management area 330, the decrease worker button 340 (the “−” button) and the worker break button 342 (the “!” button) are not displayed, and its respective row in the load management area 330 is displayed as yellow indicating a waiting state. Upon selection of the add worker button 338, the decrease worker button 340 (the “−” button) and the worker break button 342 (the “!” button) are displayed, the number of workers 344 is increased by one, and the row is displayed as green indicating a working state. Selection of the decrease worker button 340 (the “−” button) results in the number of workers 344 being decreased by one. If the number of workers 344 is zero, then the decrease worker button 340 (the “−” button) and the worker break button 342 (the “!” button) are no longer displayed.

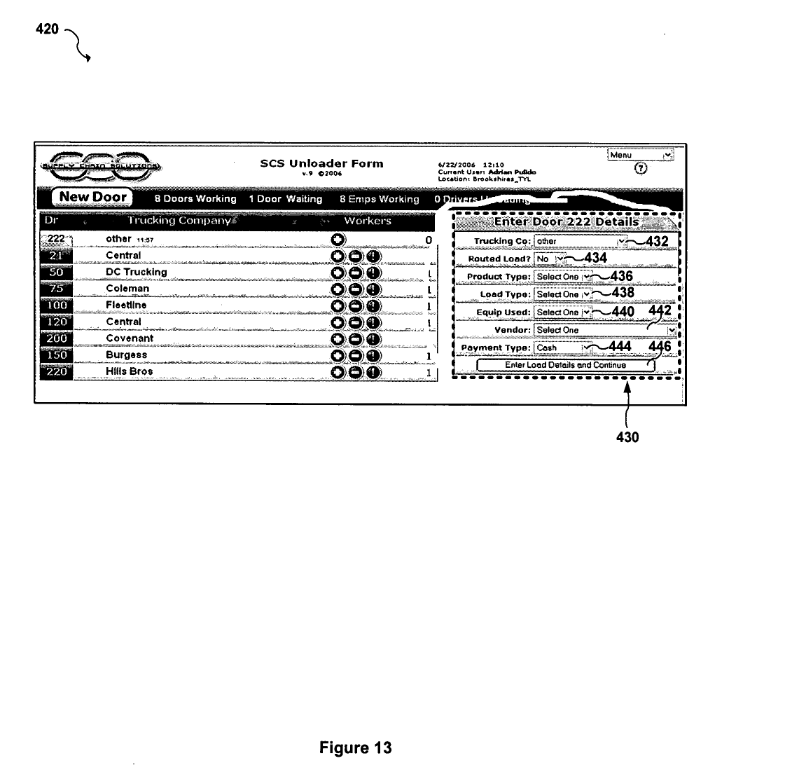

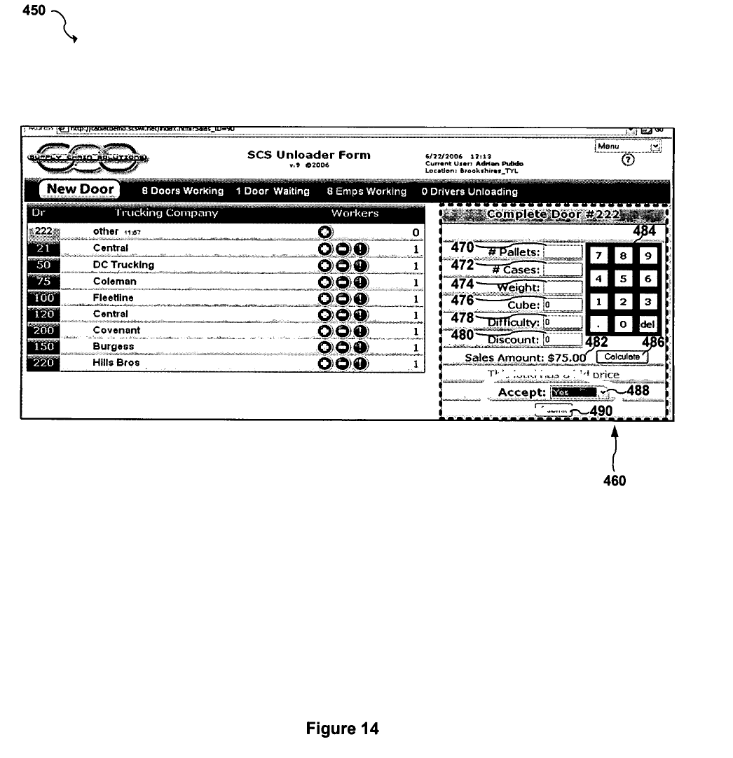

Additional load information 22 may be entered by the user at any time. In one implementation, the user may select the transportation vehicle company 384 in the load management area 330 to begin entering additional load information 22. Upon selection of the transportation vehicle company 384 in the load management area 330, the user is presented with user interface 420, as shown in FIG. 13. User interface 420 includes an enter door details area 430. Using the enter door details area 430, the user may select the transportation vehicle company 432, whether the load is routed 434, the product type 436, the load type 438, the equipment used 440, the vendor 442 and the type of payment 444. After completing the fields in the enter door details area 430, the user may select the continue button 446. In one implementation, upon selection of the continue button 446, the user is presented with user interface 450, shown in FIG. 14. User interface 450 includes a complete door area 460.

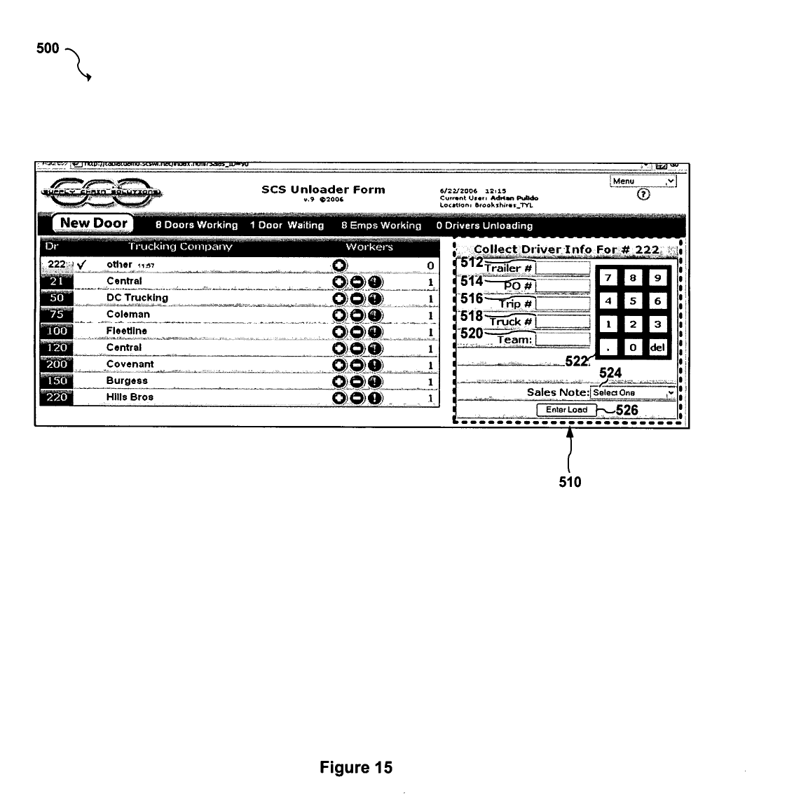

Using the complete door area 460, the user may enter the number of pallets 470, the number of cases 472, the weight of the load 474, the number of cubes 476, the difficulty of the load 478 and any discount amount 480. After completing the fields in the complete door area 460, the user may select the calculate button 486. If this is a frequent load where the price has already been set, then the load price may not be changed by the user. Optionally, a text message is displayed if the price cannot be changed. After selecting the calculate button 486 in the complete door area 460, the user then selects the submit button 490. In one implementation, upon selection of the submit button 490, the user is presented with user interface 500, as shown in FIG. 15. User interface 500 includes a collect driver information area 510.

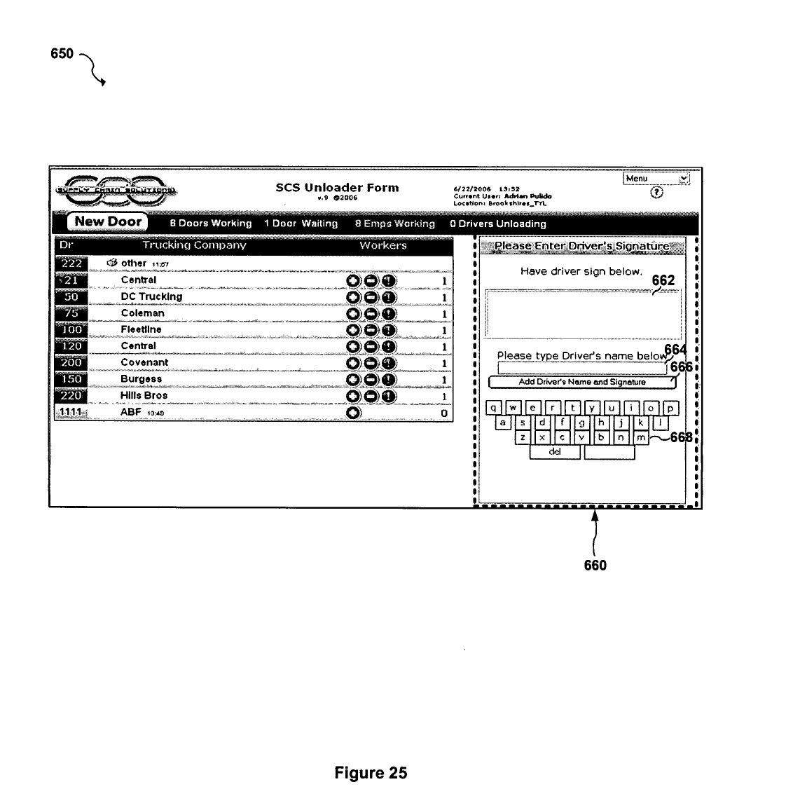

Using the collect driver information area 510, the user may enter the trailer number 512, the purchase order number 514, the trip number 516, the transportation vehicle number 518 and the team 520. The user may also select a sales note 524. After completing the fields in the collect driver information area 510, the user may select the enter load button 526. In one implementation, upon selection of the submit button 490, the user is presented with user interface 660, as shown in FIG. 25. User interface 660 includes a driver signature area 660. Using the driver signature area 660, the user or driver may enter the driver's name 664. The driver may then provide a signature in a writing area 662. After completion of the fields in the driver signature area 660, the user adds the driver information by selecting button 666.

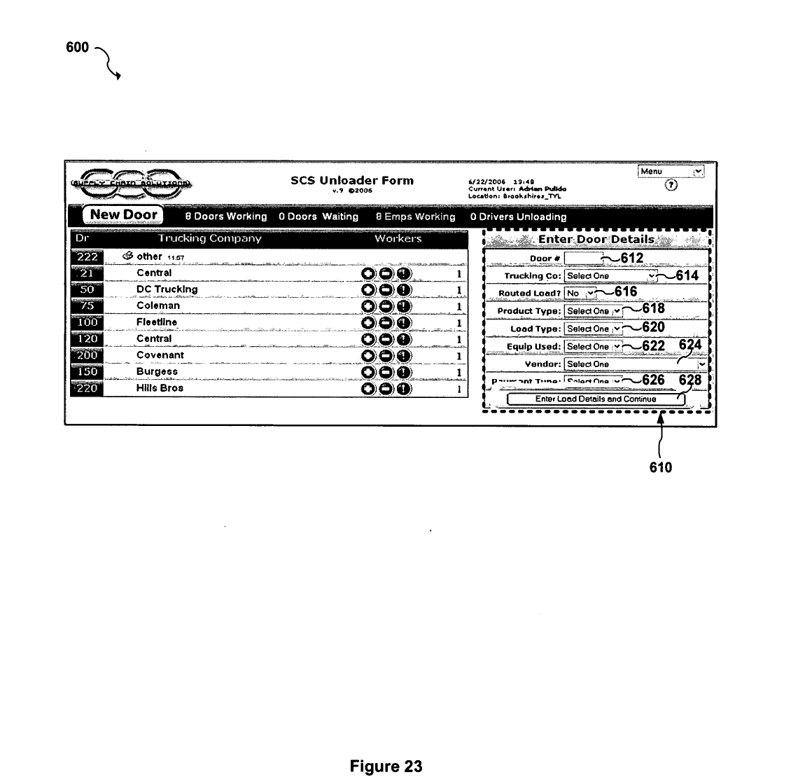

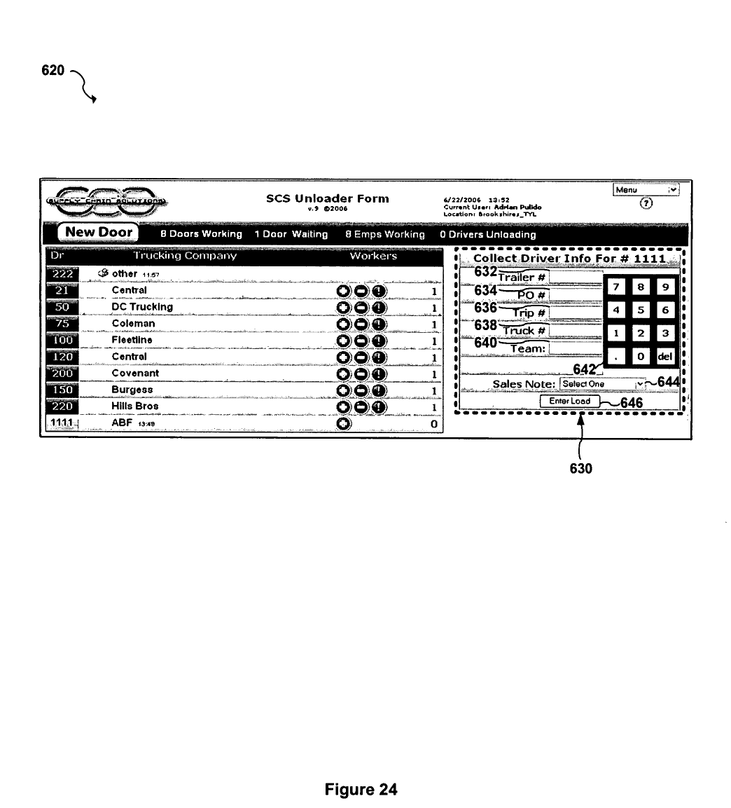

As shown at block 118 of FIG. 3, the user may choose to bid a regular load in situations where the amount to be bid is not already known and the bid price needs to be calculated based on a predefined formula. In one implementation, upon selection of the bid load button 364, the user is presented with user interface 600, as shown in FIG. 23. User interface 600 includes a door details area 610. Using the door details area 610, the user may enter a docking bay door number 612, the name of the transportation vehicle company 614, whether the load is routed 616, the product type 618, the load type 620, the equipment used 622, the vendor 624 and the type of payment 626. After completing the fields in the door details area 610, the user selects the continue button 628. In one implementation, upon selection of the continue button 446, the user is presented with user interface 450, as shown in FIG. 14. User interface 450 includes a complete door area 460 which was previously discussed. After entering the fields in the complete door area, the user selects the calculate button 486 in the complete door area 460. Upon selection of the calculate button 486, a sales amount 482 is calculated and displayed in the complete door area 460. If the driver accepts the sales amount 482, then the user selects “yes” from the accept menu 488. Otherwise, the user selects “no” from the accept menu 488. After either accepting or rejecting the sales amount 482, the user may select the submit button 490.

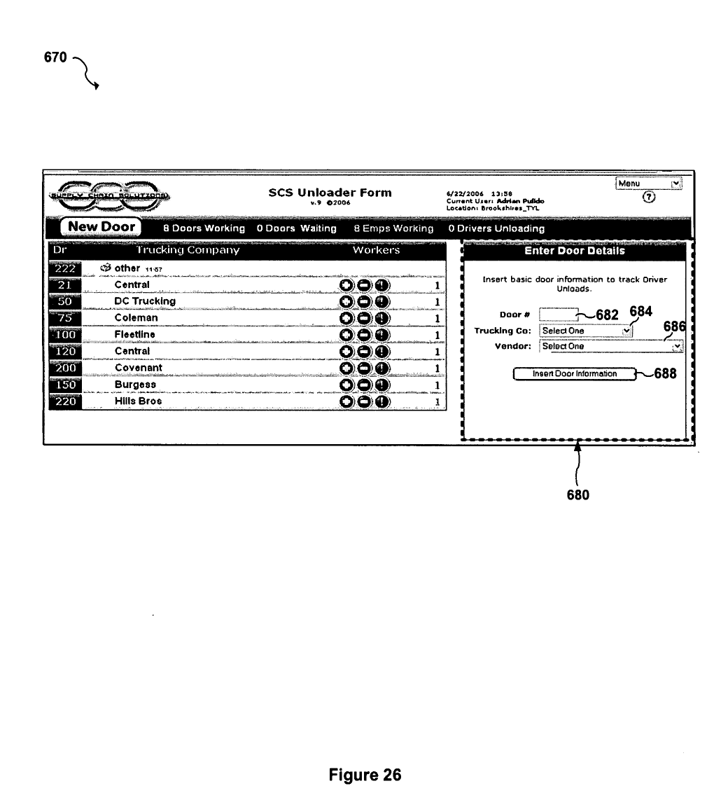

The user may also choose to enter load information relating to a driver load. In one implementation, upon selection of the driver load button 366, the user is presented with user interface 670, as shown in FIG. 26. The user may enter the door number 682, the transportation vehicle company 686 and the vendor 686. After completion of the fields in the door details area 680, the user then selects the insert door information button 688. In one implementation, upon selection of the insert information button 688, the user is presented with user interface 410, as shown in FIG. 12. At least some of the information entered in the fields of user interface 680 may be displayed along with the time that it was entered. Once the driver has finished the load, the user may choose to close the door by selecting the close door button 346.

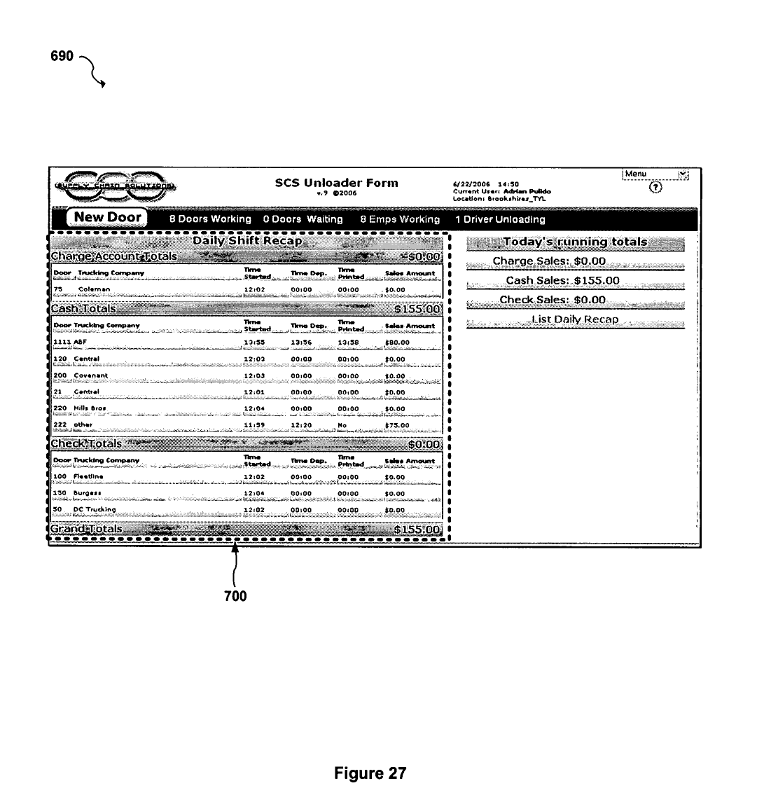

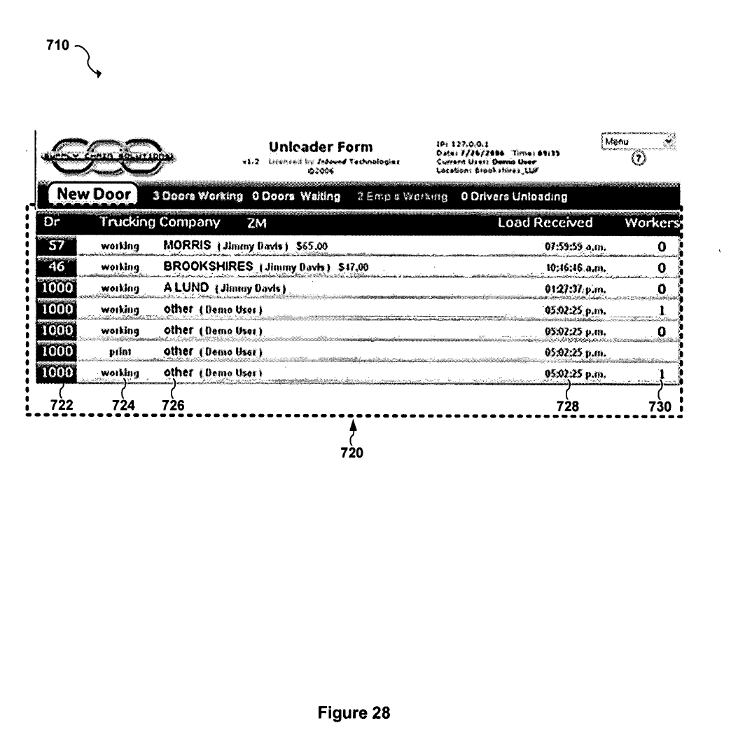

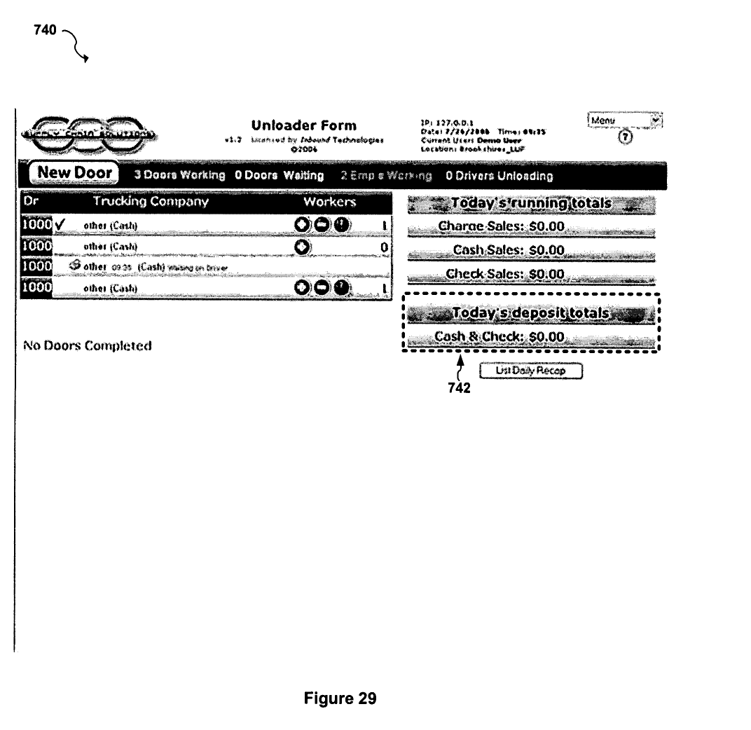

As shown at block 126 of FIG. 3, the user may choose to view or print summary information. In one implementation, the user may view summary information by selecting the daily recap button 422 of user interface 310, as shown in FIG. 1. Upon selection of the daily recap button 422, the user is presented with user interface 690, as shown in FIG. 27. User interface 690 includes a shift recap area 700. The shift recap area 700 includes a list of the loads worked during the shift, the door numbers, the transportation vehicle company names, the time the load was started, the time the load departed, and the sales amount. The daily ship recap area 700 is separated by type of payment (e.g., cash, check, or charge loads), and a grand total is listed at the bottom.

### B. Managing Workers

The user may choose to manage one or more workers as shown at block 130 of FIG. 3. Managing one or more workers includes, without limitation, adding and decreasing the number of workers assigned to load and/or unload a docking bay door (32a-32n), reassigning a worker, managing employee breaks, maintaining worker information and maintaining a traditional employee time clock, as described below.

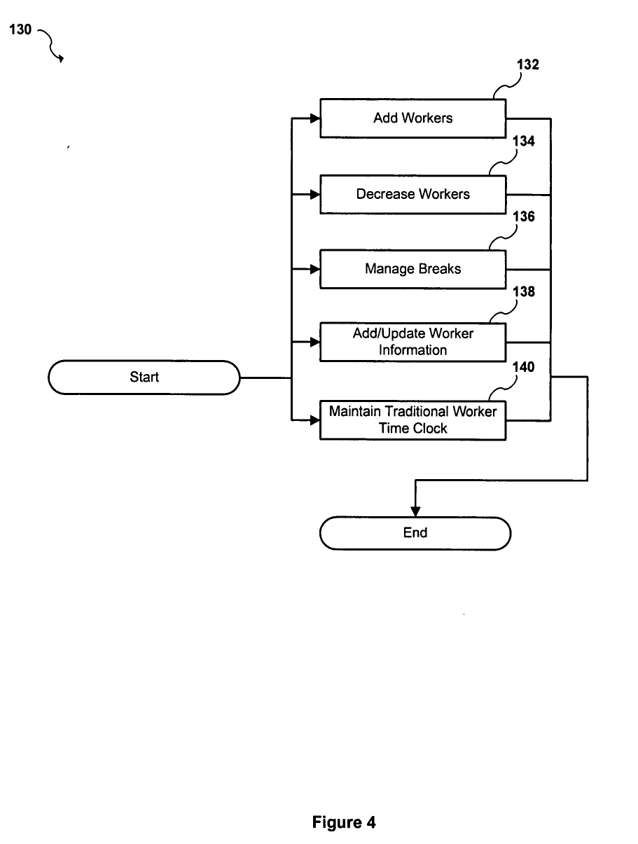

As shown at block 132 of FIG. 4, the user may choose to add (or assign) one or more workers to an open docking bay door (32a-32n). Workers are added to open docking bay doors (32a-32n) when they begin loading and/or unloading a transportation vehicle that has been associated with an open docking bay door (32a-32n). A timer is utilized to maintain the total time the workers are assigned to the open docking bay door (32a-32n). Upon the addition of a worker, the number of workers assigned to the open docking bay door (32a-32n) is increased by one and the timer reflects the additional worker. In one embodiment, a cumulative timer is maintained for all workers assigned to an open docking bay door (32a-32n). In another embodiment, a separate timer is maintained for each worker and the total time is calculated by totaling all of the individual timers. In either embodiment, the total number of workers assigned to the open docking bay door (32a-32n) and the running total time reflect each worker added to the open docking bay door (32a-32n).

As shown in FIGS. 11 and 12, the add worker button 338 (the “+” button”) may be used to add workers to an open docking bay door (32a-32n) for the purpose of loading and/or unloading a transportation vehicle. Each selection of the add worker button 338 increases the number of workers currently assigned to load and/or unload the transportation vehicle 344. Upon selection of the add worker button 338, one or more timers are updated resulting in the loading or unloading time for all workers being recorded. If workers were not previously assigned to the open docking bay door (32a-32n), selection of the add worker button 338 may also result in the decrease worker button 340 (the “−” button) and the worker break button 342 (the “!” button) being displayed. Optionally, the user may be presented with a visual indication that one or more workers are assigned to the open docking bay door (32a-32n). For instance, the dock bay door number 332 may be displayed in green when one or more workers are assigned.

As shown at block 134 of FIG. 4, the user may choose to remove (or decrease) one or more workers from an open docking bay door (32a-32n). A worker is removed from an open docking bay door (32a-32n) when the worker is no longer loading and/or unloading the transportation vehicle. Upon the removal of a worker, the number of workers assigned to the open docking bay door (32a-32n) is decreased and one or more timers are updated to reflect the decreased number of workers. The total number of workers assigned to the open docking bay door (32a-32n) and the running cumulative time reflect each worker removed from the open docking bay door (32a-32n). As shown in FIG. 12, the decrease worker button 340 (the “−” button) is used to decrease workers from an open docking bay door (32a-32n).

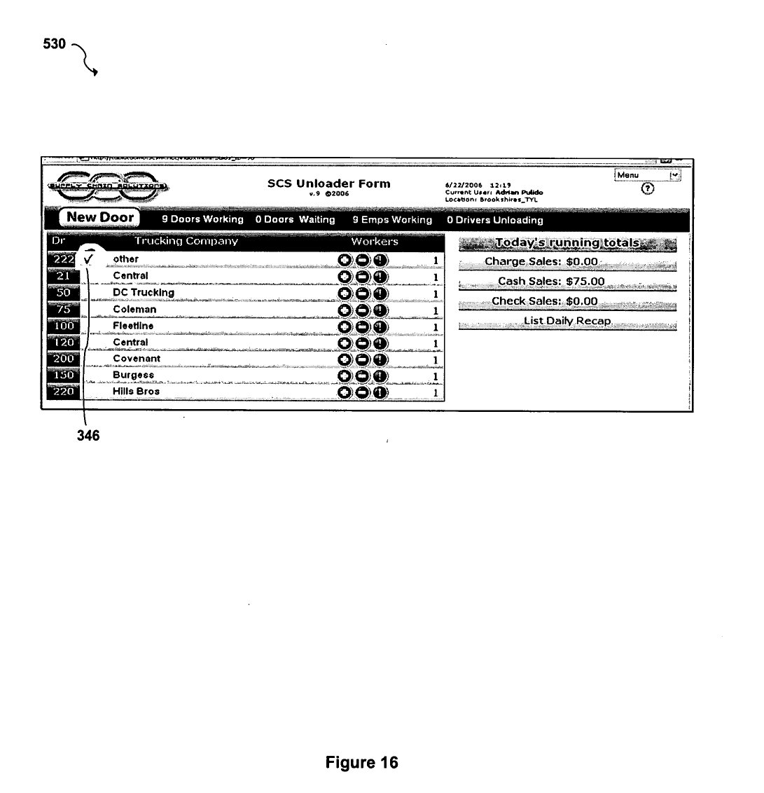

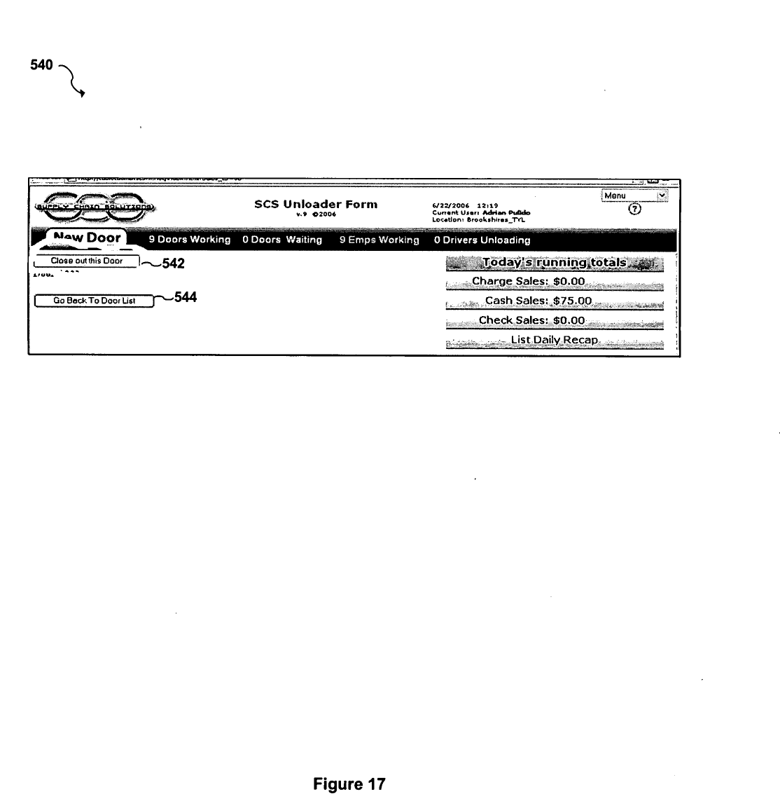

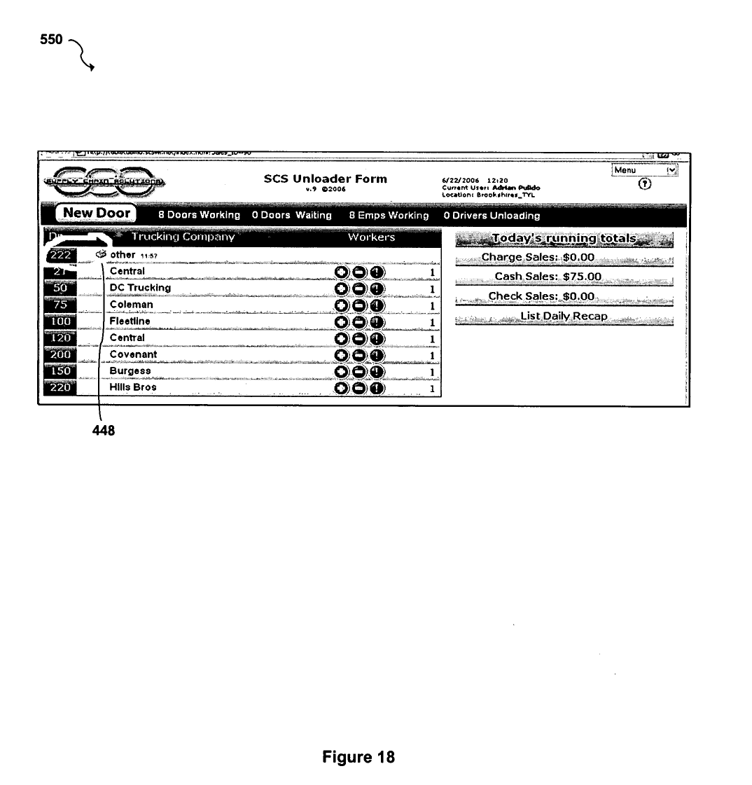

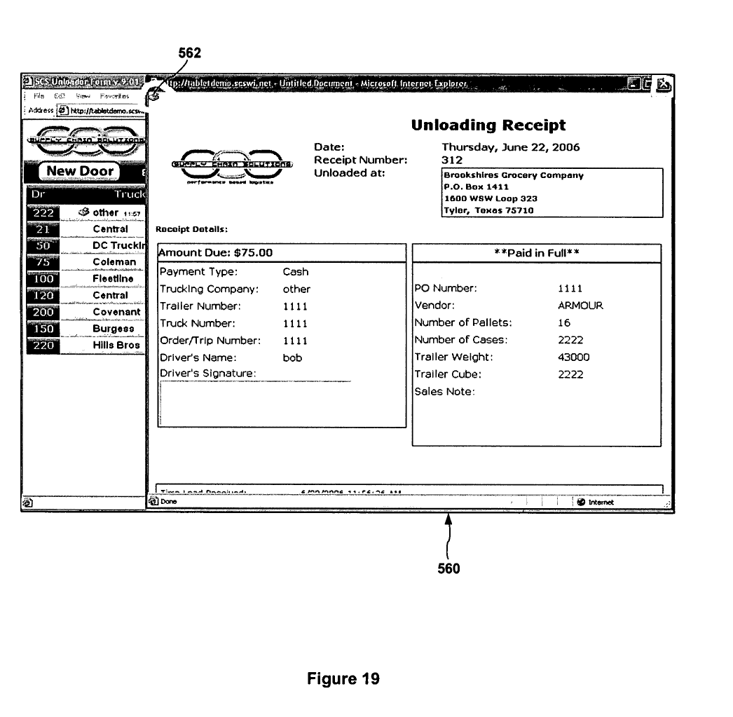

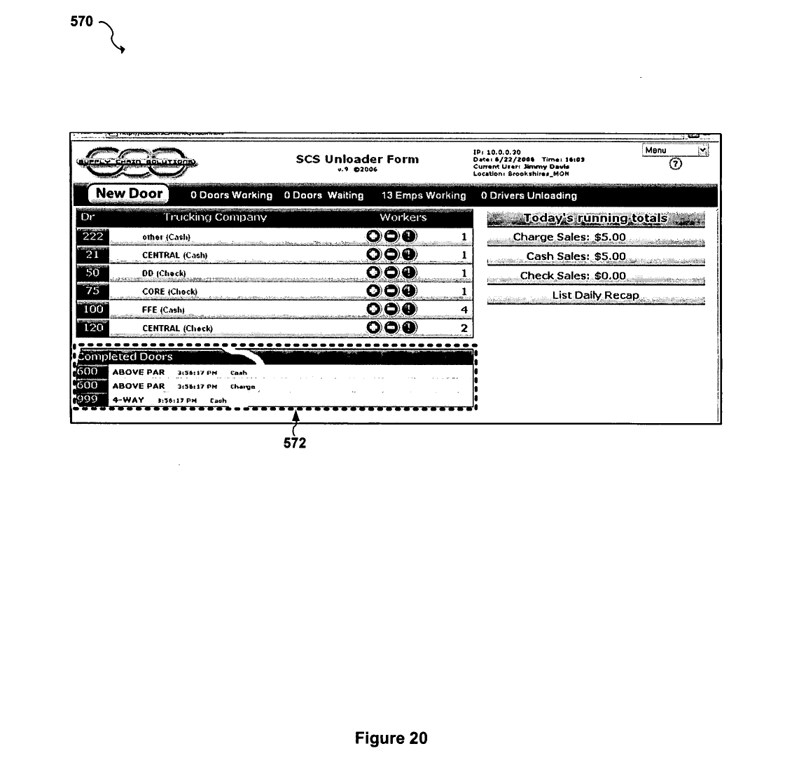

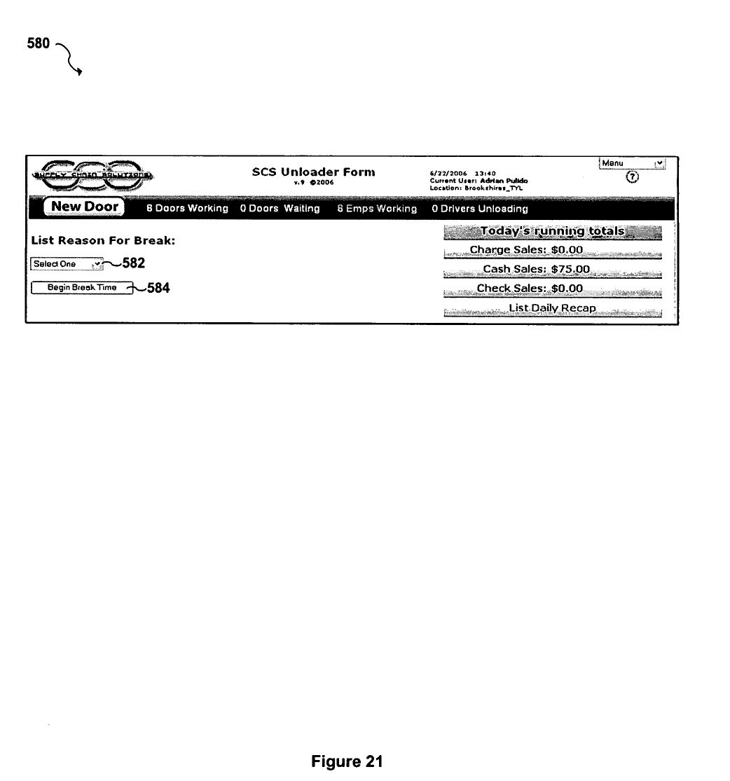

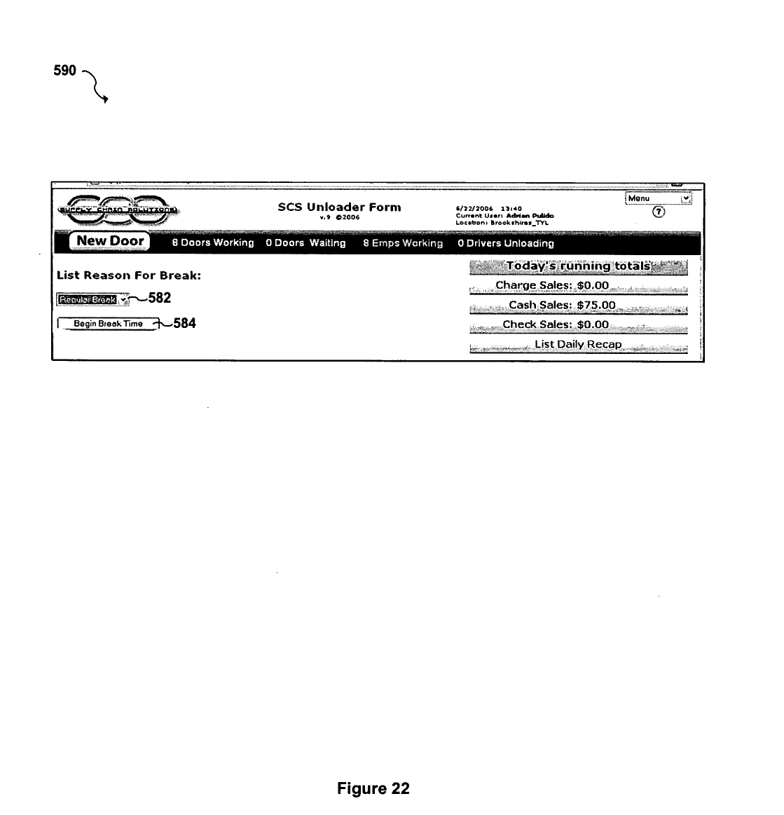

The user may also choose to close an open docking bay door (32a-32n). For instance, after the workers have completed the task of unloading a transportation vehicle, the user may close out the load and print a receipt for the driver, if necessary. In one implementation, a close door button 346 is used to close an open docking bay door (32a-32n), as shown in FIG. 16. Upon selection of the close door button 346, the user is presented with user interface 540, as shown in FIG. 17. The user may choose to continue closing the open docking bay door (32a-32n) by selecting button 542. The user may also choose to return to the previous user interface by selecting button 544. Upon selection of button 542, the user is presented with user interface 550, as shown in FIG. 18.

As shown at block 200 of FIG. 2, the user may choose to print reports or invoices. In one implementation, the user selects the printer icon 448 of user interface 550, as shown in FIG. 18, to initiate the process of printing an invoice. Upon selection of the printer icon 448, the user is presented with user interface 560, which displays the invoice. The user may then choose to print the invoice by selecting the printer icon 562 of user interface 560.

As shown at block 136 of FIG. 4, the user may choose to manage breaks for the workers assigned to load and/or unload a transportation vehicle. In one implementation, the worker break button 342 (the “!” button) is selected to start or end a break period. The user may be required to enter a reason for the break. Optionally, the break status of the workers may be visually indicated.

### C. Managing Tracking/Efficiency Information

As shown at block 170 of FIG. 2, the user may choose to manage tracking and/or efficiency information. In one embodiment, tracking information 20 relating to the task, including, without limitation, the number of man hours, the number of workers at any given time, the peak number of workers, the characteristic of the task, and the complexity of the task, is periodically stored to one or more databases 14a. Optionally, efficiency information 21, including, without limitation, the amount of time required for workers to begin working on the task and complete the task is also stored to one or more databases 14a.

### D. Determining Optimal Loading/Unloading Parameters

As previously discussed, the number of individuals needed to optimally load and/or unload articles of a transportation vehicle at a docking bay door (32a-32n) tends to fluctuate over time. Such fluctuation may be due to several factors, including, without limitation, worker availability, and the number of workers preferred at different phases of the loading and/or unloading process. Other factors may also effect the preferred number of workers, such as the availability of loading and/or unloading equipment. Based on these factors, the number of workers assigned to load and/or unload articles may vary at different phases of the process. In order to optimally load and/or unload articles, tracking information 20 relating to loading and/or unloading the transportation vehicle, including, without limitation, the number of man hours, the number of workers at any given time, the peak number of workers, the characteristic of the load, and the complexity of the load, is periodically stored in one or more databases 14a. The tracking information 20 is used to make certain efficiency calculations, such as the optimal man hours and/or the optimal number of workers to load and/or unload a transportation vehicle having similar characteristics and/or complexity.

The optimal number of workers that should be assigned at any given stage of a loading and/or unloading process and the optimal number of man hours for the assignment may be calculated by comparing the characteristic and complexity of the current load against tracking information 20 of one or more prior loads. The optimum number of workers for different phases of the task may also be calculated using this historical tracking information.

In order to determine optimal loading and/or unloading parameters, the prior loads that match the characteristic and complexity of the current load are retrieved from the one or more databases 14a. If only one prior load matches the characteristic and complexity of the current load, then the optimal loading information may be based on this one prior load. In this situation, the optimal information would merely match the tracking information 20 of the prior load. However, if more than one prior load matches the characteristic and complexity of the current load, then more accuracy in the optimized information may be provided to the user and additional calculations may be performed. For instance, the optimal loading information may be based on the average of the tracking information 20 of all prior loads at different phases or at the completion of the task. Additionally, the prior load tracking information may be grouped by the number of workers or required equipment during different phases of the task and/or the total number of man hours to perform the task. By grouping the prior load information, efficiency calculations may be performed to determine what is the optimal number of workers at any particular phase based on the efficiency of prior loads using total time or total cost analysis. The optimal loading information may then be presented to the user in text format or charted graphically, such that trends may be discovered. Optionally, loading and/or unloading information for the current load may automatically default to one or more of the parameters determined by the optimal loading information after one or more docking bay doors (32a-32n) are opened.

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise then as specifically described.

1. A computer program embodied on a computer readable medium for managing man hours of multiple individuals working one or more tasks during a predefined time period, comprising:
a first computer code for selectively opening a plurality of tasks of differing task characteristic and task type, wherein each of the open plurality of tasks has a bid price;
a second computer code for selectively associating one or more individuals to one of the open plurality of tasks;
a third computer code for selectively unassociating at least one of the associated one or more individuals, wherein one or more of the individuals are associated and unassociated prior to completion of the open one or more tasks;
a fourth computer code for maintaining at least one timer for each of the open plurality of tasks, wherein the at least one timer maintains a total time for all of the associated one or more individuals for each of the open plurality of tasks;
a fifth computer code for selectively closing one or more of the open plurality of tasks; and
a sixth computer code for selectively outputting an invoice for the closed plurality of tasks based on the bid price.

2. The computer program of claim 1, further comprising a seventh computer code for establishing the bid price to complete each of the open plurality of tasks.

3. The computer program of claim 2, wherein each of the plurality of tasks has one or more task phases, the computer program further comprises an eight computer code for determining an efficiency value associated with the one or more previously associated individuals for at least one of the plurality of tasks during at least one of the one or more task phases.

4. The computer program of claim 3, wherein the eight computer code comprises:
a ninth computer code for storing in a database historical data for one or more of the closed plurality of tasks, wherein the historical data includes the task characteristic, the task type, and the at least one timer;
a tenth computer code for selectively retrieving at least one historical data, wherein the retrieved data information substantially matches the task characteristic and the task type of one of the closed plurality of tasks; and
an eleventh computer code for calculating the difference between the at least one timer of the at least one retrieved historical data with the at least one timer of the one of the closed plurality of tasks.

5. The computer program of claim 4, wherein the at least one retrieved historical data further includes an amount of time required for one or more individuals to begin working and an amount of time required to complete the respective task.

6. The computer program of claim 5, wherein the at least one retrieved historical data comprises two or more retrieved historical data, the computer program further comprising an eleventh computer code for averaging the differences of the amount of time for each of the two or more retrieved historical data.

7. The computer program of claim 3, further comprising an ninth computer code for determining a bonus for each of the plurality of tasks, wherein the bonus is based on the efficiency value associated with each of the plurality of tasks during a predefined time period.

8. The computer program of claim 1, wherein each of the plurality of tasks has one or more task phases, the computer program further comprising a seventh computer code for determining an optimum number of individuals to associate to at least one of the open plurality of tasks during each of the one or more task phases.

9. The computer program of claim 8, wherein the seventh computer code comprises:
an eight computer code for storing in a database historical data for one or more of the closed plurality of tasks, wherein the historical data includes the task characteristic, the task type, and the at least one timer;
a ninth computer code for selectively retrieving at least one historical data, wherein the retrieved historical data substantially matches the task characteristic and the task type of one of the closed plurality of tasks; and
a tenth computer code for determining the optimal number of individuals based on the at least one timer of the at least one retrieved historical data.

10. The computer program of claim 9, wherein the at least one retrieved historical data further includes a number of associated individuals at each of the one or more phases, the peak number of individuals, a task complexity, and a task duration.

11. The computer program of claim 9, wherein the optimum number of individuals is further based on the availability of equipment.

12. The computer program of claim 1, wherein the at least one timer comprises a separate timer for each of the assigned one or more individuals.

13. The computer program of claim 1, wherein each of the plurality of tasks comprises unloading or loading articles at a corresponding one of a plurality of loading docks.

14. The computer program of claim 1, wherein the computer program is executed on one or more wireless devices in communication via a wireless network.

15. A method for managing man hours of multiple individuals working one or more tasks during a predefined time period, comprising:
selectively opening a plurality of tasks of differing task characteristic and task type, wherein each of the open plurality of tasks has a bid price;
selectively associating one or more individuals to one of the open plurality of tasks;
selectively unassociating at least one of the associated one or more individuals, wherein one or more of the individuals are associated and unassociated prior to completion of the open one or more tasks;
maintaining at least one timer for each of the open plurality of tasks, wherein the at least one timer maintains a total time for all of the associated one or more individuals for each of the open plurality of tasks;
selectively closing one or more of the open plurality of tasks; and
selectively outputting an invoice for the closed plurality of tasks based on the bid price.
